(19) United States
(12) Patent Application Publication
(10) Pub. No.: US 2018/0169582 A1
(43) Pub. Date: Jun. 21, 2018

(54) Ion Processing System

(71) Applicant: IC LLC, Troy, MI (US)

(72) Inventor: Sherif Matta, Rochester Hills, MI (US)

(21) Appl. No.: 15/842,922

(22) Filed: Dec. 15, 2017

Related U.S. Application Data
(60) Provisional application No. 62/434,859, filed on Dec. 15, 2016.

(51) Int. Cl. B01D 53/94; F02D 35/02; F02D 41/14; G01L 23/22

(52) U.S. Cl. CPC B01D 53/9431; F02D 35/021; F02P 2017/128; G01L 23/221; F02D 2200/1015; F02D 41/14

(57) ABSTRACT

An ion processing system for collecting and processing combustion information to improve engine efficiency and decrease engine emissions. The ion processing system generally includes a processing unit which is adapted to receive signals from engine sensors such as the crank sensor, injector sensor, and cam sensor. An ion sensor is provided to detect all phases of combustion and generate an ion current signal to be received by the processing unit. Signal conditioners are provided for each individual signal source (crank sensor, injector sensor, cam sensor, ion sensor) to amplify and filter the signals for optimal detection and analysis by the processing unit. The processing unit may monitor crank positioning, cam positioning, and injector timing across all stages of operation of an engine in real-time. This information may be processed and communicated to an engine control unit to improve efficiency and reduce emissions, or to a computing device for diagnostics.

### CROSS REFERENCE TO RELATED APPLICATIONS

I hereby claim benefit under Title 35, United States Code, Section 119(e) of U.S. provisional patent application Ser. No. 62/434,859 filed Dec. 15, 2016. The 62/434,859 application is currently pending. The 62/434,859 application is hereby incorporated by reference into this application.

### STATEMENT REGARDING FEDERALLY SPONSORED RESEARCH OR DEVELOPMENT

Not applicable to this application.

### BACKGROUND

### Field

Example embodiments in general relate to a ion processing system for collecting and processing combustion information to improve engine efficiency and decrease engine emissions.

### Related Art

Any discussion of the related art throughout the specification should in no way be considered as an admission that such related art is widely known or forms part of common general knowledge in the field.

Since the advent of combustion engines, efforts have been ongoing to improve engine efficiency and reduce emissions. Improvements in engine efficiency can reduce fuel costs as well as wear on the engine. Reduction of emissions is not only beneficial to the environment, but can be a requirement in some locations throughout the world due to stringent emissions regulations.

Many techniques have been pursued in an effort to directly or indirectly monitor the combustion process. Crank shaft dynamics have been utilized to detect misfiring, but have been found to fail in multi-cylinder engines and at high engine speeds. Optical sensors have been found to lack both accuracy and durability. Neural analysis techniques have been found to be limited to certain operating windows; outside of which accuracy can be negatively impacted. Other advanced sensors and pressure transducers have been utilized but have also been found to be lacking in prediction of combustion, performance, and engine emissions, as well as in cost.

### SUMMARY

An example embodiment is directed to a ion processing system. The ion processing system includes a processing unit which is adapted to receive signals from engine sensors such as the crank sensor, injector sensor, and cam sensor. An ion sensor is provided to detect all phases of combustion and generate an ion current signal to be received by the processing unit. Signal conditioners are provided for each individual signal source (crank sensor, injector sensor, cam sensor, ion sensor) to amplify and filter the signals for optimal detection and analysis by the processing unit. The processing unit may monitor crank positioning, cam positioning, and injector timing across all stages of operation of an engine in real-time. This information may be processed and communicated to an engine control unit to improve efficiency and reduce emissions, or to a computing device for diagnostics.

There has thus been outlined, rather broadly, some of the embodiments of the ion processing system in order that the detailed description thereof may be better understood, and in order that the present contribution to the art may be better appreciated. There are additional embodiments of the ion processing system that will be described hereinafter and that will form the subject matter of the claims appended hereto. In this respect, before explaining at least one embodiment of the ion processing system in detail, it is to be understood that the ion processing system is not limited in its application to the details of construction or to the arrangements of the components set forth in the following description or illustrated in the drawings. The ion processing system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a block diagram of an ion processing system in accordance with an example embodiment.

FIG. 2 is a block diagram of an ion processing system and processing unit in accordance with an example embodiment.

FIG. 3 is a block diagram of an ion processing system and engine in accordance with an example embodiment.

FIG. 4 is a block diagram of a signal conditioner of an ion processing system in accordance with an example embodiment.

FIG. 5 is a block diagram of a spark plug ion sensor of an ion processing system in accordance with an example embodiment.

FIG. 6 is a block diagram of a glow plug ion sensor of an ion processing system in accordance with an example embodiment.

FIG. 7 is a block diagram of an injector ion sensor of an ion processing system in accordance with an example embodiment.

FIG. 8 is a flowchart illustrating crank position detection by a processing unit of an ion processing system in accordance with an example embodiment.

FIG. 9 is a flowchart illustrating injector timing detection by a processing unit of an ion processing system in accordance with an example embodiment.

FIG. 10 is a flowchart illustrating cam position detection by a processing unit of an ion processing system in accordance with an example embodiment.

FIG. 11 is a flowchart illustrating ionization detection by a processing unit of an ion processing system in accordance with an example embodiment.

FIG. 12 is a flowchart illustrating signal processing by a processing unit of an ion processing system in accordance with an example embodiment.

FIG. 13 is a flowchart illustrating combustion detection by a processing unit of an ion processing system in accordance with an example embodiment.

FIG. 14 is a flowchart illustrating peak pressure detection by a processing unit of an ion processing system in accordance with an example embodiment.

FIG. 15 is a flowchart illustrating emission level detection by a processing unit of an ion processing system in accordance with an example embodiment.

### DETAILED DESCRIPTION

### A. Overview.

An example ion processing system generally comprises a crank signal conditioner 46 adapted to receive a crank position signal from a crank sensor 22 of an engine 12, an injector signal conditioner 47 adapted to receive and amplify an injector signal from an injector sensor 24 of the engine 12, and a cam signal conditioner 48 adapted to receive and amplify a cam position signal from a cam sensor 26 of the engine 12.

An ion sensor 30, such as a spark plug ion sensor 32, glow plug ion sensor 34, or injector ion sensor 36, is adapted to detect an ion signal of the engine 12. A power supply 38 shall be connected to the ion sensor 30 so as to excite the ion sensor 30 and provide a voltage which is proportional to the ion current detecting start of combustion. An ion signal conditioner 49 is adapted to receive and amplify the ion signal from the ion sensor 30.

Each of the signal conditioners 46, 47, 48, 49 may comprise an amplifier 41 and a gain adjuster 42. The amplifier 41 of each of the signal conditioners 46, 47, 48, 49 may be adapted to amplify and reduce noise of each respective signal. The gain adjuster 42 of each of the signal conditioners 46, 47, 48, 49 may be adapted to adjust a gain level of each respective signal to within a detection range of a microprocessor 52 of a processing unit 50. The gain adjuster 42 may be manual with respect to the crank signal conditioner 46, injector signal conditioner 47, and cam signal conditioner 48. The gain adjuster 42 may be automatic for the ion signal conditioner 49. The ion signal conditioner 49 may include a threshold adjuster 43 adapted to adjust a compare voltage so as to detect a start of the ion signal from the ion sensor 30. The threshold adjuster 43 is adapted to be automatically controlled by the processing unit 50 according to the signal level.

The processing unit 50 is communicatively interconnected with the crank signal conditioner 46, the injector signal conditioner 47, the cam signal conditioner 48, and the ion signal conditioner 49 so as to process the crank position signal, the injector signal, the cam position signal, and the ion signal to improve efficiency of the engine 12. The processing unit 50 may be communicatively interconnected with an engine control unit 60 of the engine 12; with the engine control unit 60 being utilized to control various components of the engine 12 in response to the processed signals so as to improve efficiency and reduce emissions.

The processing unit 50 may be adapted to detect a start of combustion of the engine 12, such as by detecting the start of the ion signal from the ion sensor 30. The processing unit 50 may adjust the start and end of combustion of the engine 12 such that the start of combustion of the engine 12 is constant with respect to a crank angle degree of the crank of the engine 12. The processing unit 50 may also detect a peak pressure of the engine 12 and communicate the peak pressure of the engine 12 to the engine control unit 60. The processing unit 50 may also be adapted to detect an emission level of the engine 12.

A further example embodiment of an ion processing system 10 may comprise an engine 12 including a crank shaft 13, an injector 14, and a cam 15. A crank sensor 22 is connected to the crank shaft 13 of the engine 12 for detecting a crank angle degree of the crank shaft 13 (engine position) at various stages during operation of the engine 12. An injector sensor 24 is connected to the injector 14 of the engine 12 for detecting injector timing of the engine 12. A cam sensor 26 is connected to the cam 15 of the engine 12 for detecting a cam position of the cam 15 at various stages during operation of the engine 12. An ion sensor 30 is connected to the engine 12 for detecting ionization due to combustion of the engine 12.

A crank signal conditioner 46 is adapted to receive, amplify, and filter a crank position signal from the crank sensor 22, an injector signal conditioner 47 is adapted to receive, amplify, and filter an injector signal from the injector sensor 24, a cam signal conditioner 48 is adapted to receive, amplify, and filter a cam position signal from the cam sensor 26, and an ion signal conditioner 49 is adapted to receive, amplify, and filter an ion signal from the ion sensor 30. A processing unit 50 is communicatively interconnected with the crank signal conditioner 46, the injector signal conditioner 47, the cam signal conditioner 48, and the ion signal conditioner 49 so as to process the crank position signal, the injector signal, the cam position signal, and the ion signal to improve efficiency of the engine. The processing unit 50 is communicatively interconnected with an engine control unit 60 of the engine 12.

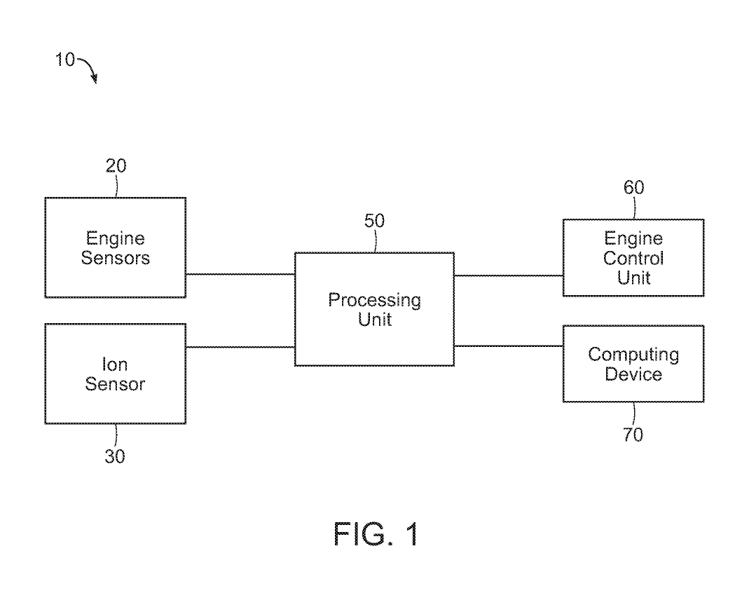

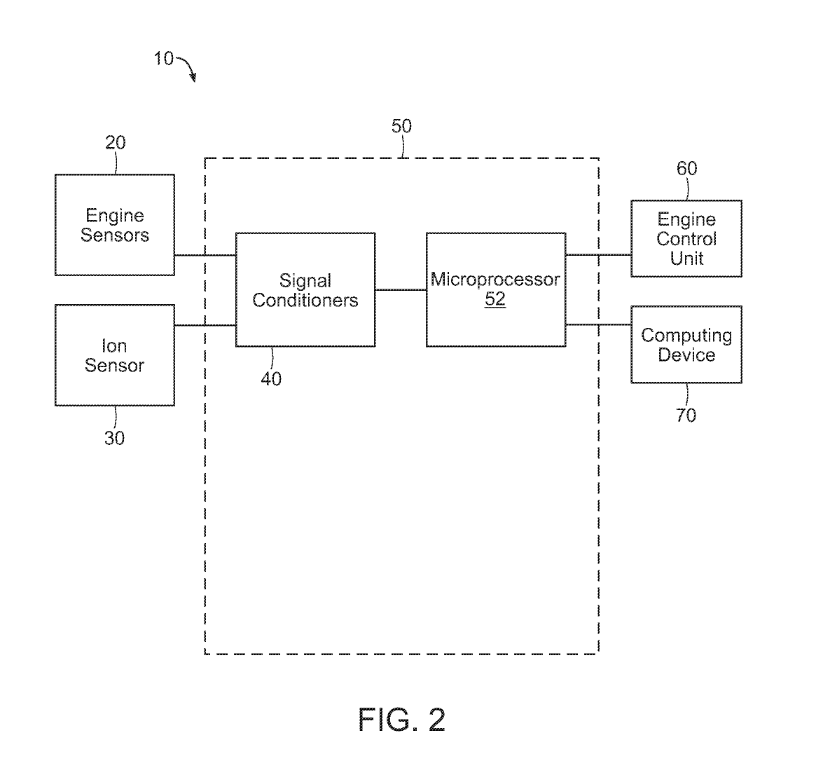

As shown in FIG. 1, a plurality of engine sensors 20 which are generally native to the engine 12 are communicatively interconnected with a processing unit 50. An ion sensor 30 for detecting ionization is also installed in the engine 12 and communicatively interconnected with the processing unit 50. The processing unit 50 may be communicatively interconnected with an engine control unit 60 for improving efficiency and reducing emissions, and to a computing device 70 for diagnostics. As shown in FIG. 2, the processing unit 50 may include signal conditioners 40 for amplifying and filtering the signals from the sensors 20, 30, and a microprocessor 52 for processing of the data.

### B. Engine Sensors.

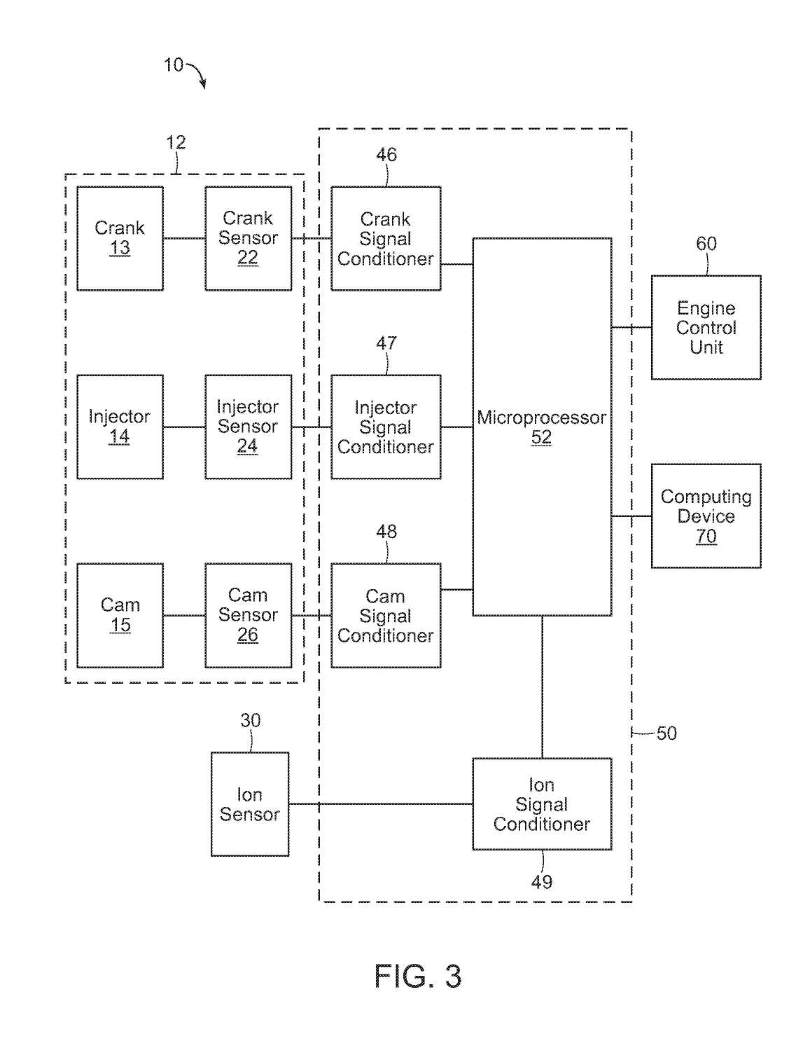

FIG. 3 illustrates an exemplary embodiment of an ion processing system 10. The systems and methods described herein may be utilized in conjunction with a wide range of combustion engines 12, including diesel, petrol, and alternative fuel engines 12. The systems and methods described herein may also be utilized with engines 12 having a wide range of numbers of cylinders. It should thus be appreciated that the type of combustion engine 12, as well as the number of cylinders in such an engine 12, may vary in different embodiments and thus should not be construed as limited by the exemplary descriptions and figures herein.

A typical engine 12 for use with the systems and methods described herein may include a crank shaft 13 which is adapted to convert linear motion of the piston(s) into rotational motion of the engine's 12 output shaft. The engine 12 may also include an injector 14 adapted to introduce fuel into the engine 12 to be combusted. The engine 12 may include one or more cams 15 which control the opening or closing of the valves of the engine 12 during operation of the engine 12. It should be appreciated that various engines 12 may comprise different configurations of cranks 13, injectors 14, and/or cams 15, and thus the scope of the present invention should not be construed as limited to any particular engine 12 configuration.

A typical engine 12 for use with the systems and methods described herein may include engine sensors 20 which are commonly incorporated into the engine 12 at time of manufacture. Such engine sensors 20 may include a crank sensor 22, an injector sensor 24, and/or a cam sensor 26. The crank sensor 22 may be adapted to detect a crank position of the crank shaft 13 of the engine 12 during various stages of operation of the engine 12. The injector sensor 24 may be adapted to detect injector timing of the engine 12 during operation thereof. The cam sensor 26 may be adapted to detect a cam position of the cam 15 of the engine 12 during various states of operation of the engine 12.

One or more of the engine sensors 20 will typically produce a signal which may be processed to collect information relating to performance of the engine 12 during all stages of the operation of the engine 12. The crank sensor 22 will typically produce a crank position signal which provides data related to the positioning of the crank shaft 13 across various stages of operation of the engine 12. The injector sensor 24 will typically produce an injector signal which provides data related to injector timing across various stages of operation of the engine 12. The cam sensor 26 will typically produce a cam position signal which provides data related to cam position across various stages of operation of the engine 12.

The processing unit 50 may be adapted to utilize one or more of the signals from the engine sensors 20 and/or ion sensor 30 to process and provide information relating to engine performance. For example, to detect start of combustion, only the ion signal and crank position signal may be necessary. As a further example, to detect peak pressure, only the ion signal, crank position signal, and injector signal may be necessary.

### C. Ion Sensor.

As shown in FIG. 3, the systems and methods described herein may include an ion sensor 30 for detecting an ion current signal which is produced by ionization of the fuel-air mixture in the combustion chamber. The ion sensor 30 may include a power supply 32 which is connected to the ion sensor 30 so as to apply an excitation voltage to a sensing electrode on the ion sensor 30. To measure the combustion ionization, the power supply 32 applies the DC voltage to the sensing electrode of the ion sensor 30 to attract ions and electrons and complete the circuit between the sensing electrode of the ion sensor 30 and the engine block and/or in-cylinder multi-engine components.

Electrons and negative ions are attracted to the positively charged sensing electrode of the ion sensor 30 while positive ions are attracted to a ground electrode or any ground path present in the cylinder. This movement of electrons and ions results in closing the ionization circuit, allowing ion current to flow through a resistor in the ion sensor 30 having a known value; the value being known to the processing unit 50. Ion current can be calculated by the processing unit 50 by dividing the measured voltage across the resistor by the resistor value, or other methods known in the art.

Various types of ion sensors 30 may be utilized. By way of example, and without limitation, the ion sensor 30 could comprise a spark plug ion sensor 32 which is incorporated into a spark plug 17 of the engine 12. As an example, the spark plug ion sensor 32 could comprise the “Spark Plug Combustion Ionization Sensor” shown and described in U.S. patent application Ser. No. 15/820,870, filed on Nov. 22, 2017, which is hereby incorporated by reference.

In engines 12 which run off diesel fuel in which a spark plug 17 is not utilized, the ion sensor 30 may comprise a glow plug ion sensor 34. In such an embodiment, the glow plug ion sensor 34 may be incorporated into a glow plug 18 of the engine 12. In other embodiments, the ion sensor 30 may comprise an injector ion sensor 36 which is incorporated into an injector 14 of the engine 12. In any case, the ion sensor 30 will detect ionization to produce an ion signal that may be amplified and filtered by the ion signal conditioner 49 and then processed by the processing unit 50.

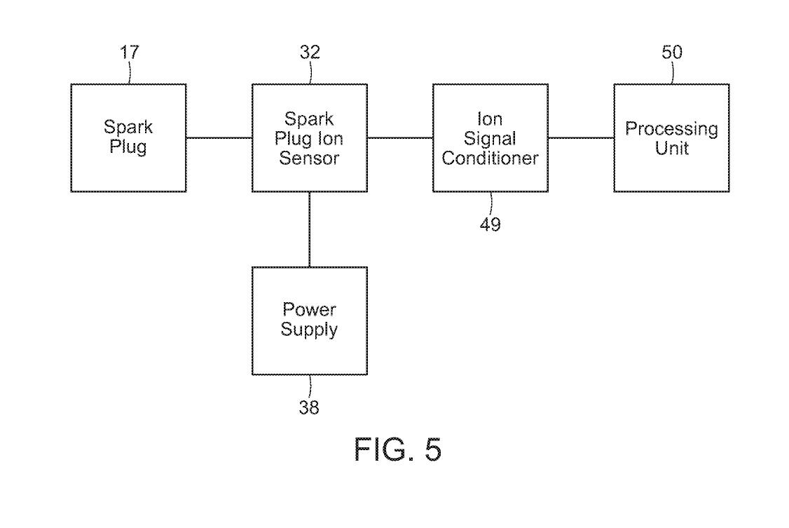

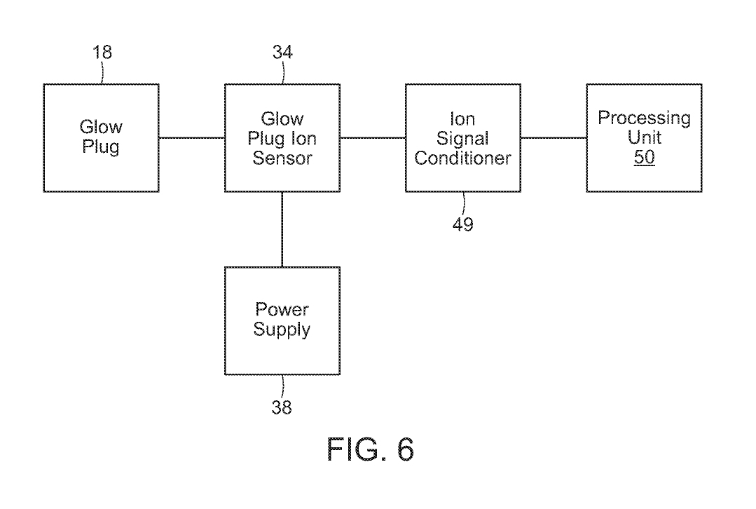

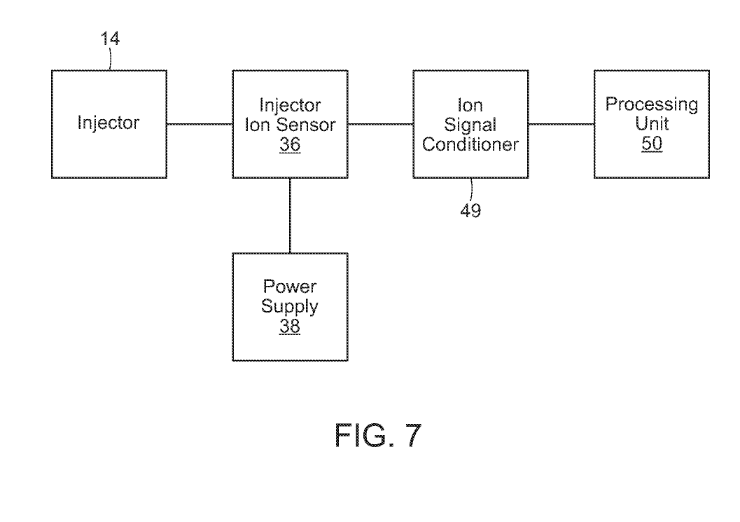

As best shown in FIGS. 5-7, a power supply 38 may be provided to apply a voltage to a sensing electrode on the ion sensor 30. The type and voltage of the power supply 38 may vary. In some embodiments, a 100 volt power supply may be utilized. The processing unit 50 will preferably be set to recognize the voltage applied to the ion sensor 30 by the power supply 38 for use in calculations and processing to determine the start and end of combustion.

The ion signal may provide an accurate representation of combustion events within the cylinder. By incorporating an ion sensor 30 into either the spark plug 17, glow plug 18, or injector 14, an ion signal may be detected from the very first generation of free ions and electrons within the combustion chamber without interference of the electromagnetic noise generated by the ignition process. In the case of multi-sparking events where multiple sparks take place within the same engine cycle, the ion signal can still be captured from start to finish with little or no interference from the ignition event.

Since the ion signal is produced by ionizing the air-fuel mixture species depending on in-cylinder temperature, pressure, equivalence ratio and other parameters, it is possible to quantify the ionized species and obtain combustion and emission parameters using the measured ion signal. The ion signal obtained from the ion sensor 30 may be used as a feedback signal to provide cycle-by-cycle and cylinder-by-cylinder control over the combustion process in the engine 12. In conjunction with the processing unit 50 described herein, this control can be used to improve efficiency of the engine 12 and reduce emissions. The ion sensor 30 may also be utilized to detect combustion abnormalities such as engine knocking, misfires, or late firing.

The ion signal may be combined and compared with the crank position signal, cam position signal, and/or injector signal to determine various information related to operation of the engine 12. Use of the ion signal in combination with the other signals allows the processing unit 50 to continuously determine and monitor the crank position, cam position, and injector timing across all combustion events within the engine 12. As discussed herein, the collation of this information may be utilized by the processing unit 50 to improve efficiency of the engine 12 and to reduce emissions.

### D. Signal Conditioners.

During operation of the engine 12, various signals will be generated by the engine sensors 20 and ion sensor 30 across all stages of combustion and engine 12 operation. During certain stages of operation, such as when the engine 12 is idling or at low power, the signals may be relatively weak (represented by a low current). In the past, such weak signals have caused problems relating to accuracy in measurement of the various operations of the engine 12. To combat this problem, signal conditioners 40 may be utilized to amplify and filter the signals before they are communicated to the processing unit 50.

During normal operation of the engine 12, the crank sensor 22 will continuously produce a crank position signal which indicates positioning of the crank shaft 13. The injector sensor 24 will continuously produce an injector signal which indicates the timing of the injector 14. The cam sensor 26 will continuously produce a cam position signal which indicates positioning of the cam 15. The ion sensor 30 will continuously produce an ion signal which can be used to determine information about combustion events within the engine 12, such as the start and end of combustion.

Each of these individual signals has their own amplitudes which may vary widely during operation of the engine. While one particular signal may be readable by the processing unit 50, one or more of the other signals may be below or above the threshold of the microprocessor 52 of the processing unit 50 for accurate readings. Thus, each of the sensors 20, 30 will preferably include its own signal conditioner 40. In this manner, individual signals may be amplified or filtered by different values depending on the specifics of that particular signal.

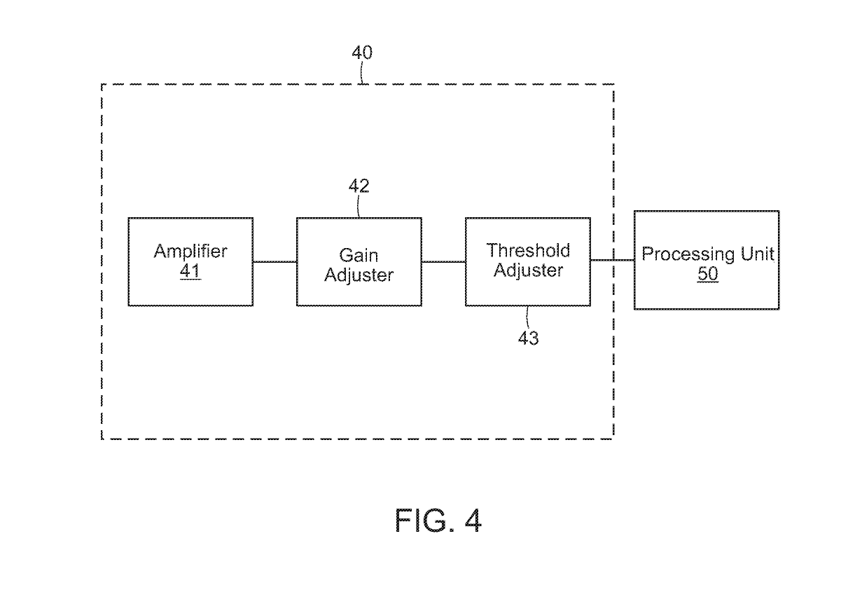

FIG. 4 illustrates an exemplary signal conditioner 40. The signal conditioner 40 may include an amplifier 41 which is adapted to amplify the signal and reject noise. The amplifier 41 may also be utilized to remove DC offset within the signal. A gain adjuster 42 may be utilized to automatically amplify the signal when the signal amplitude is very low and reduce the signal if the signal amplitude is very high. A threshold adjuster 43 may be utilized to adjust the compare voltage which is used to detect the start of the signal.

The gain adjuster 42 may adjust a gain level applied to the signal before processing by the processing unit 50. The processing unit 50 may have a range of current which it is configured to accurately detect. If the signal is outside of that range, the gain adjuster 42 will make the necessary adjustments to the gain level to bring the signal into the optimal range for the particular processing unit 50 being utilized.

It should be appreciated that different gain adjusters 42 may be utilized for different components of the ion processing system 10. For example, the gain adjusters 42 used for the crank signal conditioner 46, injector signal conditioner 47, and cam signal conditioner 48 may be manually set by the processing unit 50; as the strength of those signals will generally be constant during operation and thus will not need variable gain during operation. The gain adjuster 42 of the ion signal conditioner 49 may be automatic so as to automatically adjust during operation. This accounts for the varying strength of the ion signal during various driving, operating, and engine 12 conditions.

The optimal detection range of a particular processing unit 50 may vary in different embodiments, and will typically be determined by the particular microprocessor 52 used in the processing unit 50. By way of example and without limitation, some microprocessors 52 may have optimal detection ranges between 10 and 100 micro amps. If the signal generated by the sensors 20, 30 is below the optimal detection range, a higher gain will be applied to boost the signal before transferring to the processing unit 50. If the signal generated by the sensors 20, 30 is above the optimal detection range, a lower gain will be applied to the signal before transferring to the processing unit 50. In this manner, the signal conditioners 40 may ensure that each of the signals is well within the optimal range of the processing unit 50 to prevent inaccurate readings or other complications which can impact overall operation of the processing unit 50.

As mentioned previously, each sensor 20, 30 will preferably have its own signal conditioner 40 so that each signal may be individually amplified and filtered to accommodate for different signal strength of the various sensors across all stages of operation of the engine 12. As shown in FIG. 3, the crank sensor 22 may include a crank signal conditioner 46. The injector sensor 24 may include an injector signal conditioner 47. The cam sensor 26 may include a cam signal conditioner 48. The ion sensor 30 may include an ion signal conditioner 49. Each of the signal conditioners 46, 47, 48, 49 is connected to the processing unit 50 such that the amplified and filtered signals may be transferred to the processing unit 50 for processing.

### E. Processing Unit.

As best shown in FIG. 3, a processing unit 50 receives and processes the signals from the sensors 20, 30 after amplification and filtering by the signal conditioners 40. The processing unit 50 may be adapted to detect and process signals from the sensors 20, 30. The processing unit 50 may also exert control over various functions of the engine 12, such as by sending signals from the processing unit 50 to the injector 14, spark plug 17, and/or glow plug 18. The processing unit 50 may comprise a printed circuit board which is stored within a housing; the housing being adapted to receive various connectors to communicatively interconnect the processing unit 50 with the engine sensors 20, engine control unit 60, and/or a separate computing device 70.

As best shown in FIG. 3, the processing unit 50 may comprise a microprocessor 52 such as a digital signal processor which is adapted to receive and process the various signals received from the sensors 20, 30 via the signal conditioners 40. The microprocessor 52 may be adapted to process various information and send data over a communications network, such as to the engine control unit 60 or a computing device 70. Various types of microprocessors 52 may be utilized, and the scope of the present invention should not be construed as limited to any particular type of microprocessor 52.

The processing unit 50 may communicatively interact with various other components of ion processing system 10 via various communications protocols, such as Flexray, Universal Serial Bus, or Ethernet. The processing unit 50 may communicatively interact with the Controller Area Network (CAN) or the Local Interconnect Network (LIN) of the engine 12. If the engine has an ignition control module, the processing unit 50 may be communicatively interconnected within the ignition control module.

The processing unit 50 may execute a software application which performs various functions of the ion processing system 10. The software application may be utilized by the processing unit 50 to process the signals to determine to start and end of combustion, as well as the crank shaft 13 and cam 15 positioning and injector 14 timing across all stages of operation. The software application may be stored on a storage device (such as a hard drive, flash card, or the like) or may be flashed directly onto the microprocessor 52 of the processing unit 50. The processing unit 50 may be communicatively interconnected with the engine control unit 60 of the engine 12. In this manner, the operation of the engine 12 may be adjusted by the processing unit 50 dependent upon the processing of the various signals so as to improve efficiency and reduce emissions of the engine 12. The signal conditioners 40 ensure that the processing unit 50 can detect all signals clearly even when the engine 12 is idling at very low engine speed.

The processing unit 50 may also be communicatively interconnected with a computing device 70. The computing device 70 may comprise a computer, laptop, tablet, smart phone, or any other type of computing device 70. The software application may process the signals and send signal parameters to the computing device 70 for further processing. The manner in which the computing device 70 is interconnected with the processing unit 50 may vary. There may be a wired connection (such as via USB or Ethernet) or a wireless connection (such as via a communications network such as the Internet, or via Bluetooth).

The processing unit 50 may provide a wide range of functionalities with respect to the signals received from the sensors 20, 30 via the signal conditioners 40. What follows is merely an exemplary listing of potential uses of the processing unit 50. The functionalities of the processing unit 50 should not be construed as limited by the exemplary descriptions or figures herein.

The processing unit 50 may be adapted to provide a higher resolution estimation of the crank angle degree based on engine acceleration. The processing unit 50 may also be utilized to set an expected range algorithm to expect the detection range of the signals being received by the processing unit 50. Additionally, the processing unit 50 may be adapted to convert any of the signals into digital with uniform resolution and sampling time regardless of the engine speed. The processing unit 50 may also be adapted to process the ion signal and provide signal characteristics for further processing by the engine control unit 60 and/or computing device 70.

### F. Operation of Preferred Embodiment.

The methods and systems described herein allow for collection of combustion information in an effort to improve engine efficiency and decrease engine emissions. The ion processing system 10 operates as part of the entire engine management system by communicating to the engine control unit 60 to provide the necessary information for better engine control. In some embodiments, the ion processing system 10 may require initial calibration for different engine configurations.

The ion processing system 10 is adapted to compute in real-time the combustion and emission levels, thereby enhancing engine control and onboard diagnostics. Thus, the ion processing system 10 leads to optimal engine performance (such as higher fuel economy), low carbon footprint, decreased toxic engine-out emissions (such as nitrogen oxides and soot), and minimal combustion noise, vibration, and harshness. The ion processing system 10 is adapted to decode and evaluate the real-time signals as well as collecting any information that is pertinent to achieving closed-loop control.

The systems herein may be applied to engines 12 at manufacture, or may be applied to engines 12 at a later time without substantial modification to the engine 12. No holes or the like need to be drilled in the engine 12, such as in the cylinder heads, as is common in other sensing systems. The processing unit 50 is preferably adapted to be easily secured within the engine compartment and interconnected with the various other components of the ion processing system 10.

In use, the processing unit 50 may first be connected to the sensors 20, 30 via the signal conditioners 40. The processing unit 50 may produce basic information about engine combustion, performance, and emissions parameters on a cylinder-to-cylinder and cycle-to-cycle basis such that the engine 12 may be fine-tuned to meet its targets over its lifetime.

The processing unit 50 may be stored in a compact housing that may be connected within the engine compartment of the vehicle. The manner and location of mounting the processing unit 50 to the engine or engine compartment may vary in different embodiments and should not be construed as limited in any manner. Brackets, slots, cables, or the like may be utilized to secure the processing unit 50.

The engine sensors 20 are typically native to the engine 12, as most modern engines 12 include various engine sensors 20 to provide various information about the engine's 12 operation to the engine control unit 60. Thus, the processing unit 50 is preferably communicatively interconnected with each of the engine sensors 20 so that a signal from each may be communicated to the processing unit 50. The processing unit 50 may be connected to each of the sensors by a cable or the like which connects between the particular engine sensor 20 and the processing unit 50.

In the embodiment shown in the exemplary figures, the processing unit 50 is interconnected with each of the crank sensor 22, injector sensor 24 and cam sensor 26 of the engine 12. The crank sensor 22 provides a crank position signal to the processing unit 50 for determining positioning of the crank shaft 13 across all stages of operation. The injector sensor 24 provides an injector signal to the processing unit 50 for determining various aspects of the fuel injection of the engine 12 across all stages of operation. The cam sensor 26 provides a cam position signal to the processing unit 50 for determining positioning of the cam 15 across all stages of operation.

Each of these signals may be amplified and filtered by their own signal conditioner 40; with the crank signal being amplified and filtered by the crank signal conditioner 46, the injector signal being amplified and filtered by the injector signal conditioner 47, and the cam signal being amplified and filtered by the cam signal conditioner 48. Use of individual signal conditioners 40 for each signal accounts for variations in amplitude and noise in each of the signals individually to provide better readings across all stages of operation.

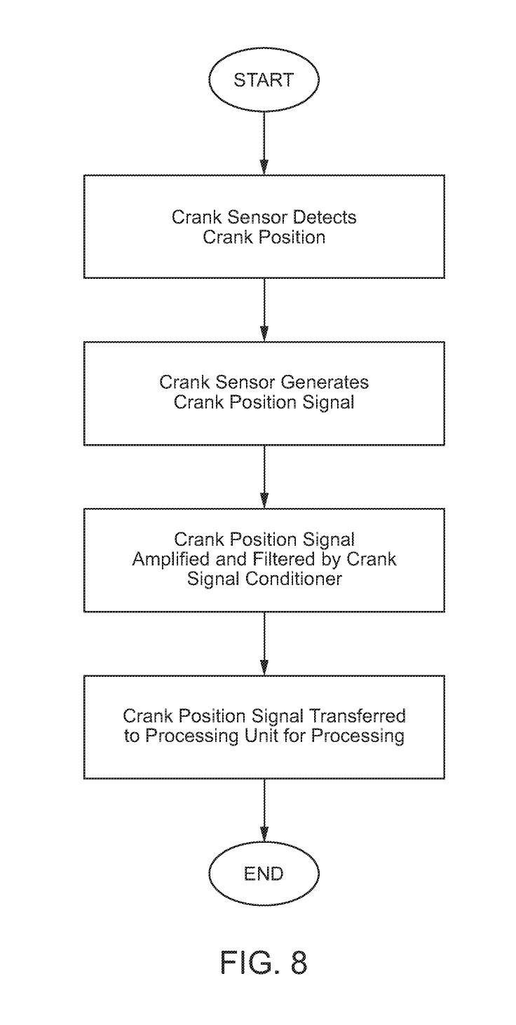

FIG. 8 illustrates exemplary operation of the crank sensor 22 with the ion processing system 10. As shown, the crank sensor 22 first detects crank position and generates a crank position signal. The crank position signal is amplified and filtered by the crank signal conditioner 46 before being transferred to the processing unit 50 for processing.

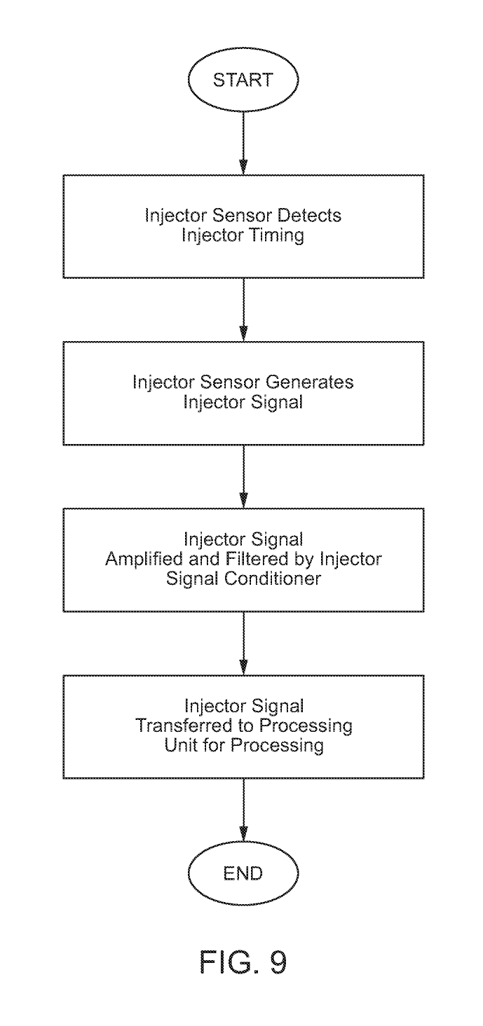

FIG. 9 illustrates exemplary operation of the injector sensor 24 with the ion processing system 10. As shown, the injector sensor 24 first detects fuel injection timing and then generates an injector signal. The injector signal is amplified and filtered by the injector signal conditioner 47 before being transferred to the processing unit 50 for processing.

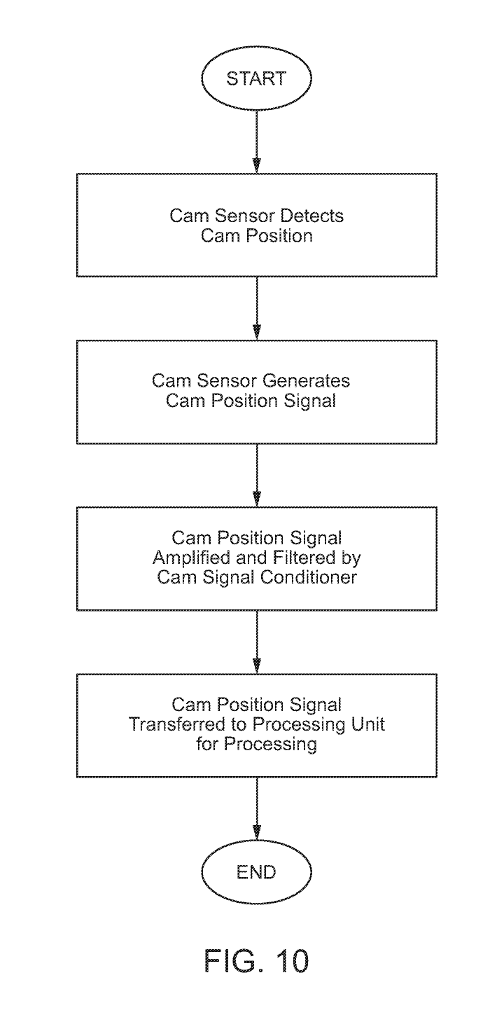

FIG. 10 illustrates exemplary operation of the cam sensor 26 with the ion processing system 10. As shown, the cam sensor 26 first detects cam positioning and then generates a cam position signal. The cam position signal is amplified and filtered by the cam signal conditioner 48 before being transferred to the processing unit 50 for processing.

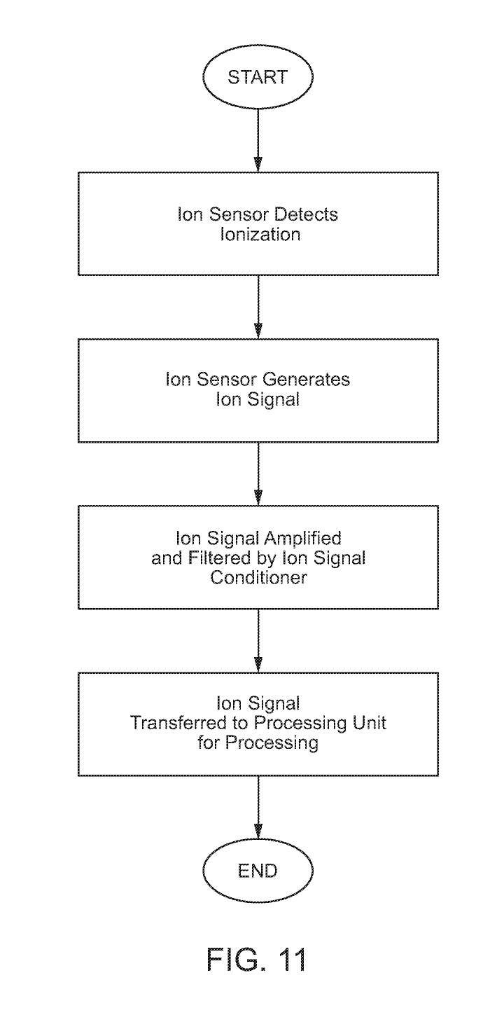

FIG. 11 illustrates exemplary operation of the ion sensor 30 (whether it be a spark plug ion sensor 32, glow plug ion sensor 34, or injector ion sensor 36). The ion sensor 30 first detects ionization and generates an ion signal. The ion signal is amplified and filtered by the ion signal conditioner 49 before being transferred to the processing unit 50 for processing.

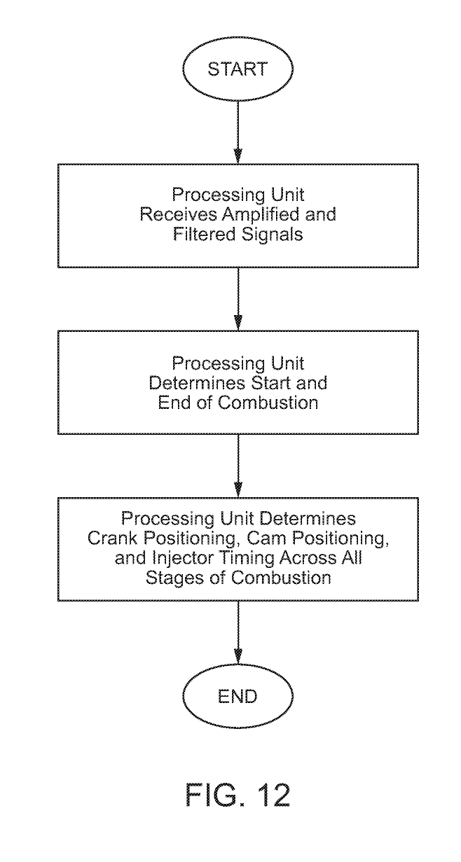

FIG. 12 illustrates receipt and processing of the signals by the processing unit 50. As shown, the processing unit 50 continuously receives the amplified and filtered signals (crank position signal, injector signal, cam position signal, and ion signal). The signal conditioners 40 will individually amplify and filter each signal separately to stay within an optimal detection range of the microprocessor 52 being used. The processing unit 50 is able to determine the start and end of combustion via the ion signal. With this information, the processing unit 50 is able to continuously, in real-time, detect crank positioning, cam positioning, and injector timing across all stages of combustion.

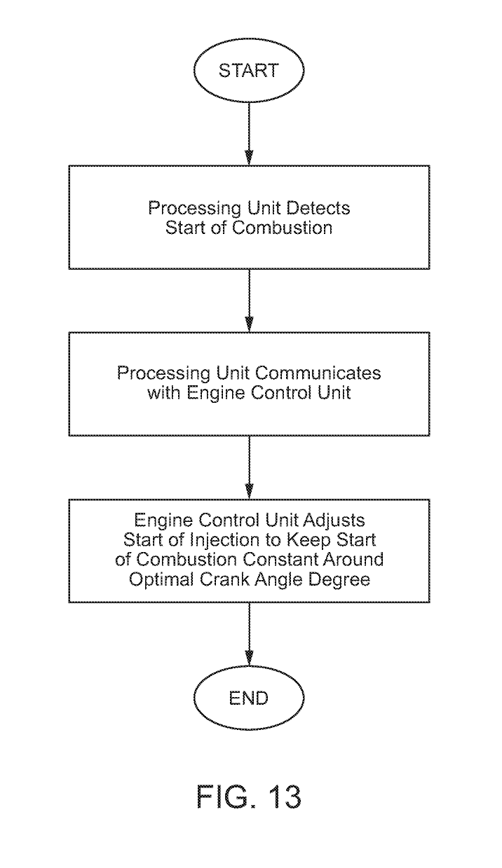

FIG. 13 illustrate transfer of information from the processing unit 50 to the engine control unit 60 to perform various functionality. With reference to FIG. 13, the processing unit 50 detects the start of combustion and communicates with the engine control unit 60. The engine control unit 60 may adjust start of injection to keep start of combustion constant around optimal crank angle degrees with the data received from the processing unit 50.

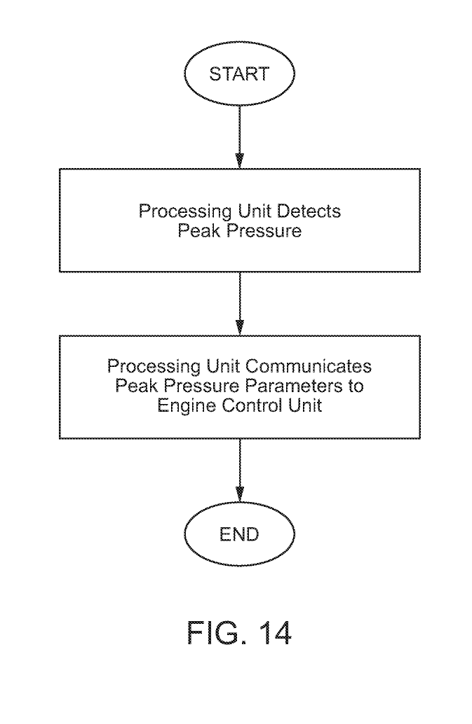

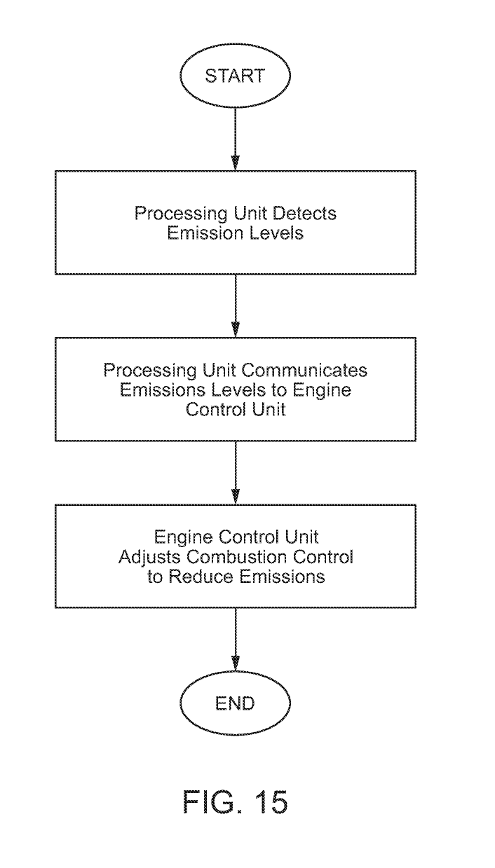

With reference to FIG. 14, the processing unit 50 may be adapted to detect peak pressure. Data related to peak pressure may be communicated to the engine processing unit 50 so that adjustments may be made to improve efficiency. With reference to FIG. 15, the processing unit 50 may detect emissions levels and communicate the same to the engine control unit 60. The engine control unit 60 may adjust combustion control to reduce emissions.

A number of methods may be utilized to determine start and end of combustion. A group of hardware comparators may be utilized for hardware detection. In the event hardware detection fails, then a software detection method may be utilized to read the ion signal via an analog-to-digital converter and then processing the converted signal by the processing unit 50. If software detection fails, the maximum amplitude of the ion signal may be found and signal processing by the processing unit 50 may be utilized to search back and forth on the signal for the start and end of combustion.

Unless otherwise defined, all technical and scientific terms used herein have the same meaning as commonly understood by one of ordinary skill in the art to which this invention belongs. Although methods and materials similar to or equivalent to those described herein can be used in the practice or testing of the ion processing system, suitable methods and materials are described above. All publications, patent applications, patents, and other references mentioned herein are incorporated by reference in their entirety to the extent allowed by applicable law and regulations. The ion processing system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. An ion processing system, comprising:
a crank signal conditioner adapted to receive a crank position signal from a crank sensor of an engine;
an injector signal conditioner adapted to receive and amplify an injector signal from an injector sensor of the engine;
a cam signal conditioner adapted to receive and amplify a cam position signal from a cam sensor of the engine;
an ion sensor adapted to detect an ion signal of the engine;
an ion signal conditioner adapted to receive and amplify the ion signal from the ion sensor; and
a processing unit communicatively interconnected with the crank signal conditioner, the injector signal conditioner, the cam signal conditioner, and the ion signal conditioner, wherein the processing unit is adapted to process the crank position signal, the injector signal, the cam position signal, and the ion signal to improve efficiency of the engine.

2. The ion processing system of claim 1, wherein the processing unit is adapted to be communicatively interconnected with an engine control unit of the engine, the engine control unit being adapted to control the engine.

3. The ion processing system of claim 1, wherein the processing unit is adapted to be communicatively interconnected with a computing device, the computing device being adapted to process and display information related to performance of the engine.

4. The ion processing system of claim 1, further comprising a power supply connected to the ion sensor.

5. The ion processing system of claim 1, wherein the ion sensor comprises a glow plug ion sensor.

6. The ion processing system of claim 1, wherein the ion sensor comprises a spark plug ion sensor.

7. The ion processing system of claim 1, wherein the ion sensor comprises an injector ion sensor.

8. The ion processing system of claim 1, wherein the crank signal conditioner, the injector signal conditioner, the cam signal conditioner, and the ion signal conditioner each comprise an amplifier and a gain adjuster.

9. The ion processing system of claim 8, wherein the amplifier is adapted to amplify and reduce noise of the crank signal, the injector signal, the cam signal, or the ion signal.

10. The ion processing system of claim 9, wherein the gain adjuster is adapted to adjust a gain level of the crank signal, the injector signal, the cam signal, or the ion signal to within a detection range of a microprocessor of the processing unit.

11. The ion processing system of claim 8, wherein the ion signal conditioner comprises a threshold adjuster adapted to adjust a compare voltage so as to detect a start of the ion signal.

12. The ion processing system of claim 1, wherein the processing unit is adapted to detect a start of combustion of the engine.

13. The ion processing system of claim 12, wherein the processing unit is adapted to adjust the start of combustion of the engine such that the start of combustion of the engine is constant with respect to a crank degree angle of a crank of the engine.

14. The ion processing system of claim 1, wherein the processing unit is adapted to calculate a peak pressure of the engine, wherein the processing unit is adapted to communicate the peak pressure of the engine to the engine control unit.

15. The ion processing system of claim 1, wherein the processing unit is adapted to calculate an emission level of the engine.

16. An ion processing system, comprising:
an engine including a crank, an injector, and a cam;
a crank sensor connected to the crank of the engine for detecting a crank angle degree of the crank;
an injector sensor connected to the injector of the engine for detecting injection timing of the engine;
a cam sensor connected to the cam of the engine for detecting a cam position of the cam;
an ion sensor connected to the engine for detecting ionization due to combustion of the engine;
a crank signal conditioner adapted to receive, amplify, and filter a crank position signal from the crank sensor;
an injector signal conditioner adapted to receive, amplify, and filter an injector signal from the injector;
a cam signal conditioner adapted to receive, amplify, and filter a cam position signal from the cam;
an ion signal conditioner adapted to receive, amplify, and filter an ion signal from the ion sensor; and
a processing unit communicatively interconnected with the crank signal conditioner, the injector signal conditioner, the cam signal conditioner, and the ion signal conditioner, wherein the processing unit is communicatively interconnected with an engine control unit of the engine, wherein the processing unit is adapted to process the crank position signal, the injector signal, the cam position signal, and the ion signal to improve efficiency of the engine.

17. The ion processing system of claim 16, wherein the ion sensor comprises a spark plug ion sensor.

18. The ion processing system of claim 16, wherein the ion sensor comprises a glow plug ion sensor.

19. The ion processing system of claim 16, wherein the ion sensor comprises an injector ion sensor.

20. The ion processing system of claim 16, wherein the crank signal conditioner, the injector signal conditioner, the cam signal conditioner, and the ion signal conditioner each comprise an amplifier and a gain adjuster.
